(19) United States
(12) Patent Application Publication
(10) Pub. No.: US 2010/0206072 A1
(43) Pub. Date: Aug. 19, 2010

(54) MICROMECHANICAL COMPONENT AND METHOD FOR OPERATING A MICROMECHANICAL COMPONENT

(75) Inventors: Lars Tebje, Reutlingen (DE); Fouad Bennini, Reutlingen (DE); Wolfgang Fuerst, Reutlingen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/601,689

(22) PCT Filed: Sep. 29, 2008
(86) PCT No.: PCT/EP2008/062989

§ 371 Date: May 10, 2010

(30) Foreign Application Priority Data
Oct. 30, 2007 (DE) 10 2007 051 871.6

(51) Int. Cl. G01C 19/56

(52) U.S. Cl. 73/504.12

(57) ABSTRACT

A micromechanical component may include fixed electrodes and a seismic mass, the seismic mass being connected via a suspension element to a carrier substrate and being movable with respect to it. The seismic mass may include counterelectrodes, which are interconnected via a first electrically conductive connection. The fixed electrodes may include measuring electrodes and decoupled electrodes, the measuring electrodes being provided to function for an electrical evaluation, and the counterelectrodes situated across from the decoupled electrodes being provided to function as a frequency band-altering mechanical element.

### FIELD OF THE INVENTION

The present invention relates to a micromechanical component having electrodes, for example, where an electrical base capacitance of the electrodes is decoupled from a frequency band modification by the electrodes, and to a method for operating such a micromechanical component.

### BACKGROUND INFORMATION

German Patent Application DE 198 17 357 A1 describes an acceleration sensor, for example, which has a carrier substrate and a seismic mass, where an acceleration parallel to a main plane of extension of the substrate effects a deflection of the seismic mass with respect to the carrier substrate, the deflection occurring capacitively by electrodes rigidly connected to the seismic mass and counterelectrodes rigidly connected to the carrier substrate. The electrical base capacitance of the movable mass as well as the damping of the deflecting motion of the seismic mass depend on the number of electrodes and are therefore linked to each other.

### SUMMARY OF THE INVENTION

In contrast to the related art, the micromechanical component according to example embodiments and of the present invention and according to example methods of the present invention for operating a micromechanical component have an advantage that the electrical base capacitance of the electrodes is decoupled from the frequency band modification by the electrodes. The electrical base capacitance is formed essentially by the accumulation of the individual capacitances between the movable counterelectrodes and the associated or opposite fixed electrodes. A low base capacitance is advantageous for this purpose, allowing in particular for the use of smaller reference capacitances, which allows for a micromechanical component according to the present invention, for an example, an acceleration sensor, on a comparatively small carrier substrate surface. At the same time, the number of counterelectrodes determines the frequency band of the mechanical deflection of the seismic mass, which is particularly advantageously adapted, depending on the requirement, to the micromechanical component during the manufacturing process. According to an example embodiment of the present invention, decoupling the base capacitance and the frequency band is achieved in that only a portion of the fixed electrodes are electrically contacted and function as measuring electrodes. The measuring electrodes essentially determine the electrical base capacitance of the seismic mass, while the counterelectrodes on the seismic mass situated across from the decoupled electrodes only function as frequency band-altering mechanical elements because the decoupled electrodes are short-circuited for example with the seismic mass and thus no electrical capacitance is active between the two. The change of position and/or the bandwidth modification of the frequency band of the relative motion of the seismic mass with respect to the carrier substrate when acceleration forces occur in the carrier substrate plane is achieved by a change of the total mass of the seismic mass via a change of the number of counterelectrodes situated across from the decoupled electrodes, while other conditions remain the same. The change of the number of counterelectrodes may be effected by adapting the number of decoupled electrodes. Consequently, it is possible to optimize the frequency behavior for the desired acceleration forces to be measured in the carrier substrate plane without changing the base capacitance.

In an example embodiment, another modification of the frequency behavior of the seismic mass is possible by friction forces between the counterelectrodes, which are situated across from the decoupled electrodes, and a gaseous medium in the micromechanical component, the frequency behavior being additionally modifiable, for example, by a suitable gas pressure in the micromechanical component. This allows in particular for the damping behavior of the micromechanical component to be adapted. Compared to the related art, the decoupling of base capacitance and frequency band according to the present invention makes it therefore particularly advantageously possible to implement a small base capacitance having a variably adjustable deflection frequency band of the seismic mass. In particular, a low base capacitance of the electrodes allows for a low reference capacitance and therefore a comparatively small required carrier substrate surface and thus significant cost savings in manufacture and a substantial simplification of the microelectronic implementation of the micromechanical component.

According to an example embodiment of the present invention, at least one measuring electrode has an electrode pair, the counterelectrode being situated between the electrodes of the electrode pair, and the electrodes of the electrode pair being provided to be at different electrical potential. Advantageously, this structure allows for a differential evaluation of the electrical voltages of the electrode pair with advantages of differential circuit technology, in particular the increase of measuring accuracy and the improvement of noise sensitivity with respect to electrical and electromagnetic interferences.

According to an example embodiment, the electrode pair has a first and a second electrode, the first electrodes and the second electrodes of a plurality of electrode pairs being interconnected respectively via a second and a third electrically conductive connection. Advantageously, the electrical capacitance of the plurality of first and second electrodes therefore accumulates and a joint evaluation of the electrode pairs becomes possible.

According to an example embodiment, the decoupled electrodes are provided to be at least in part interconnected via fourth electrically conductive connections. Such electrically conductive connections are advantageous particularly with respect to stray capacitances, in particular by the fact that these are clearly definable and therefore capable of being compensated.

According to an example embodiment, additional fifth electrically conductive connections are provided between the fourth electrically conductive connections and the counterelectrodes such that in particular the decoupled electrodes are electrically connected to the seismic mass. Particularly advantageously, no electrical capacitance is thus acting between the decoupled electrodes and the seismic mass.

According to an example embodiment, the relative motion is electrically evaluated by a multitude of interconnected first and second electrodes of electrode pairs. Advantageously, this type of evaluation results in an accumulation of the electrical capacitances of the plurality of first and second electrodes and a joint evaluation of the electrode pairs becomes possible.

A method, according to example embodiments of the present invention, for operating a micromechanical component may be performed in which an electrical evaluation of the relative motion of the counterelectrode with respect to the measuring electrode is performed only by the measuring electrode, and in which the mechanical damping, in particular a shifting, widening, and/or narrowing of the frequency band, of the relative motion is achieved by the counterelectrodes situated across from the decoupled electrodes. This advantageously achieves the decoupling of the base capacitance of the counterelectrodes with respect to the fixed electrodes and the damping of the seismic mass by the counterelectrodes.

### BRIEF DESCRIPTION OF THE DRAWINGS

FIG. 1 schematically shows a top view of a portion of a micromechanical component, according to an example embodiment of the present invention.

FIG. 2 is an electrical equivalent circuit diagram of an electrode pair and a counterelectrode of a micromechanical component, according to an example embodiment of the present invention.

### DETAILED DESCRIPTION

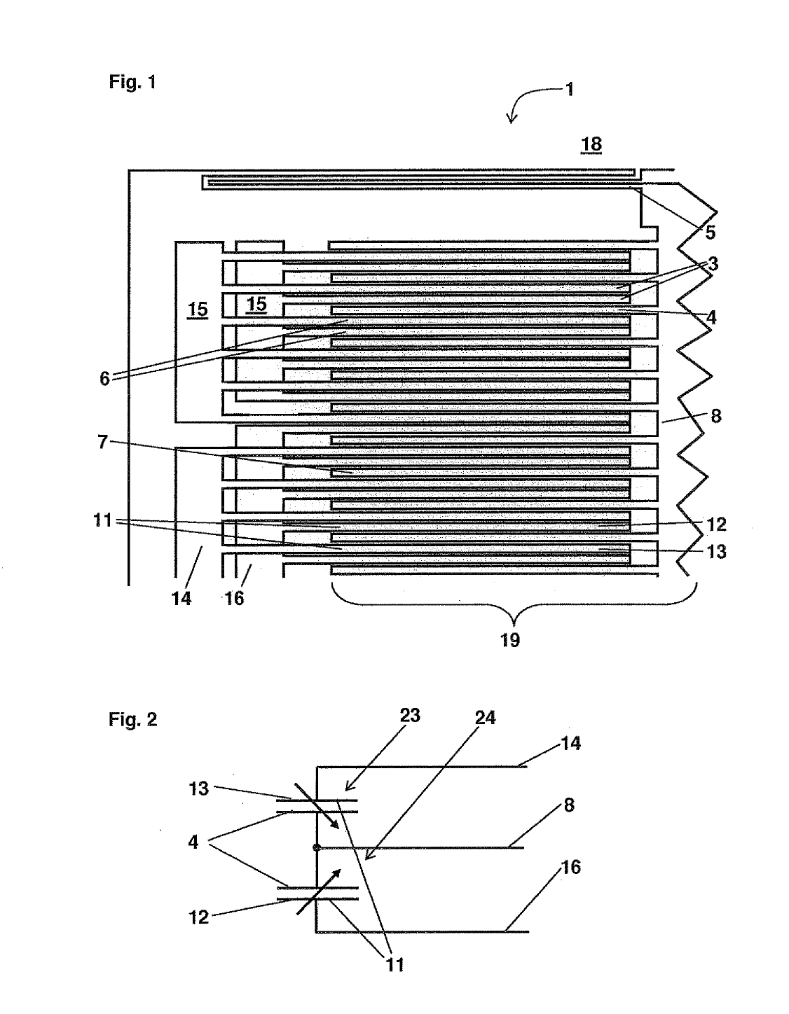

FIG. 1 schematically shows top view of a portion of a micromechanical component, according an example embodiment of the present invention. The view shows a micromechanical component 1, for example, a portion of an acceleration sensor. The micromechanical component 1 has fixed electrodes and a seismic mass 19, seismic mass 19 being connected via suspension elements 5 to a carrier substrate 18 and being movable with respect to it. The seismic mass 19 has counterelectrodes 4, which are interconnected via a first electrically conductive connection 8, and fixed electrodes 3. The electrodes include measuring electrodes 7 and decoupled electrodes 6 not connected to measuring electrodes 7 via electrically conductive connections. Measuring electrodes 7 each includes one electrode pair 11, electrode pair 11 respectively having a first and a second electrode 12, 13, and first electrodes 12 and second electrodes 13 of all electrode pairs 11 being respectively interconnected via second and third electrically conductive connections 14, 16. Decoupled electrodes 6 are at least in part connected to one another via fourth electrically conductive connections 15.

FIG. 2 shows an electrical equivalent circuit diagram of an electrode pair and a counterelectrode of a micromechanical component of an example embodiment of the present invention. Two plate-type capacitors 23, 24 are shown, which each respectively includes one respective measuring electrode and one respective counterelectrode 4. The short-circuited capacitor plates 4 represent counterelectrode 4 and the outer capacitor plates 12, 13 represent the first and the second electrodes 12, 13 of electrode pair 11, first and second electrodes 12, 13 being respectively connected via second and third conductive connection 14, 16 to additional first and second electrodes that are not shown here. Counterelectrode 4 is a part of the seismic mass and is connected to additional counterelectrodes (not shown) via first electrically conductive connection 8, a deflection of the seismic mass from the rest position by an occurring acceleration force in the plane of carrier substrate 18 effecting a change in the distance of the capacitor plates in plate-type capacitors 23, 24 in such a way that the capacitance of the one plate capacitor is increased and at the same time the capacitance of the other plate-type capacitor is lowered. The change of the capacitances in the respective plate-type capacitors 23, 24 is detected by voltage signals in the conductive connections 14, 16.

1-10. (canceled)

11. A micromechanical component, comprising:
a carrier substrate;
fixed electrodes, including measuring electrodes and decoupled electrodes;
suspension elements;
a first electrically conductive connection;
a seismic mass connected via the suspension elements to the carrier substrate, the seismic mass being movable with respect to the carrier substrate;
wherein:
the seismic mass includes counterelectrodes that are interconnected via the first electrically conductive connection, the counterelectrodes including counterelectrodes that are situated across from the decoupled electrodes;
the measuring electrodes perform an electrical evaluation function; and
the counterelectrodes situated across from the decoupled electrodes function as a frequency band-altering mechanical element.

12. The micromechanical component as recited in claim 11, wherein only one highly resistive connection is provided between a measuring electrode and a decoupled electrode.

13. The micromechanical component as recited in claim 11, wherein at least one of the measuring electrodes includes a respective electrode pair of electrodes that are at different electrical potential and between which one of the counterelectrodes is situated.

14. The micromechanical component as recited in claim 11, further comprising:
a second electrically conductive connection; and
a third electrically conductive connection;
wherein:
each of a plurality of the measuring electrodes includes a respective electrode pair;
each of at least two of the electrode pairs includes a respective first electrode and a respective second electrode;
the first electrodes of a plurality of the electrode pairs are interconnected via the second electrically conductive connection; and
the second electrodes of a plurality of the electrode pairs are interconnected via the third electrically conductive connection.

15. The micromechanical component as recited in claim 11, further comprising:
second electrically conductive connections, wherein the decoupled electrodes are at least in part interconnected via the second electrically conductive connections.

16. The micromechanical component as recited in claim 15, further comprising:
third electrically conductive connections between the second electrically conductive connections and the counterelectrodes.

17. The micromechanical component as recited in claim 11, wherein the micromechanical component function as an acceleration sensor.

18. A method for operating a micromechanical component comprising: a carrier substrate; fixed electrodes, including measuring electrodes and decoupled electrodes; suspension elements; a first electrically conductive connection; a seismic mass connected via the suspension elements to the carrier substrate, the seismic mass being movable with respect to the carrier substrate and including counterelectrodes that are interconnected via the first electrically conductive connection and that include counterelectrodes that are situated across from the decoupled electrodes, the method comprising:
the measuring electrodes performing an electrical evaluation of a relative motion of the counterelectrodes with respect to the measuring electrodes; and
the counterelectrodes situated across from the decoupled electrodes effecting a mechanical damping of the relative motion.

19. The method as recited in claim 18, wherein the counterelectrodes situated across from the decoupled electrodes function as a frequency band-altering mechanical element.

20. The method as recited in claim 18, wherein the electrical evaluation of the relative motion is performed by at least one measuring electrode via a pair of electrodes between the electrodes of which one of the counterelectrodes is situated.

21. The method as recited in claim 18, wherein:
each of a plurality of the measuring electrodes includes a respective electrode pair;
each of at least two of the electrode pairs includes a respective first electrode and a respective second electrode;
the first electrodes of a plurality of the electrode pairs are interconnected via a second electrically conductive connection;
the second electrodes of a plurality of the electrode pairs are interconnected via a third electrically conductive connection; and
the electrical evaluation of the relative motion is performed by a plurality of the first and second electrodes.
